(19) United States
(12) Patent Application Publication
(10) Pub. No.: US 2013/0004643 A1
(43) Pub. Date: Jan. 3, 2013

(54) METHOD OF MAKING SWEET POTATO BREAD

(76) Inventor: Chan Seol PARK, Yeongju-si (KR)

(21) Appl. No.: 13/530,377

(22) Filed: Jun. 22, 2012

(30) Foreign Application Priority Data
Jun. 29, 2011 (KR) 10-2011-0063483

(51) Int. Cl. A21D 2/04; A21D 6/00

(52) U.S. Cl. 426/551

(57) ABSTRACT

The present invention provides a method of making a sweet potato bread. The method includes: forming a sweet potato paste by steaming sweet potatoes, cutting the steamed sweet potatoes, and mashing the cut sweet potatoes by using a masher; forming a mixed paste by mixing the sweet potato paste and bean-based paste or pumpkin-based paste in the weight ratio of 1:0.05 to 0.3; forming a dough by mixing flour, sugar, eggs, table salt, starch syrup, baking powder, and sodium hydrogen carbonate and kneading the mixture; and forming a bread shaped dough by cutting the dough to a predetermined size, adding the mixed paste to the cut dough, and then shaping the cut dough into a bread shape.

### CROSS-REFERENCE TO RELATED APPLICATIONS

This application claims the benefit of Korean Patent Application No. 10-2011-0063483, filed on Jun. 29, 2011, in the Korean Intellectual Property Office, the disclosure of which is incorporated herein in its entirety by reference.

### BACKGROUND 1. Field

The present invention relates to a method of making a sweet potato bread using sweet potato paste.

2. Description of the Related Art

Sweet potatoes eaten as a staple food or snack are excellent source of carbohydrates and contain mostly starch, with some water. In addition to grains such as rice or barley, sweet potatoes have been used as a main food resource. Also, sweet potatoes, which are a source of natural β-carotene, minerals, vitamins, and dietary fiber, have verified nutrition and functions, and thus the sweet potatoes are used as materials of convenience foods, favorite foods, and nutritional supplements.

In particular, sweet potatoes have high in calories because of lots of sugar and vitamin C and less water, detoxify benzopyrene that is a kind of carcinogen, and can prevent adult diseases because of lots of vegetable fiber. Also, sweet potatoes contain lots of potassium and thus are effective in lowering blood pressure and stress.

Recently, as nutrition and functions of sweet potatoes have been known through various researches and experiments, the demands for sweet potatoes increase. Also, various processed goods using sweet potatoes, methods of forming the processed goods, and various recipes using sweet potatoes are being developed.

Also, from among the various processing goods using sweet potatoes, sweet potatoes are used to make cakes, breads, and the like in the bakery industry. However, conventionally, cakes and breads using sweet potatoes are made by using only ingredients of the sweet potatoes, and the cakes and the breads using sweet potatoes are made without regard to the shapes of the sweet potatoes or the addition of other ingredients.

Korean Patent Registration No. 10-0549785 discloses a method of forming a bread using sweet potatoes. This method includes a paste forming process for steaming sweet potatoes, mixing white bean paste, sugar, acacia honey, and eggs with the steamed sweet potatoes at a predetermined rate and stirring them; a dough forming process for mixing strong flour, middle flour, glutinous rice flour, eggs, powdered milk, salt, baking powder, mugwort powder, and cocoa powder at a predetermined rate and adding water to the mixture to form dough; a shaping process for filling the inside of the dough with paste to shape the dough into a sweet potato shape; and a baking process for baking the dough in an oven. The bread formed by using the above-described method cannot sufficiently provide taste and smell of sweet potatoes, and also cannot be stored and distributed for a long period of time.

### SUMMARY

The present invention provides a method of forming a sweet potato bread containing sweet potatoes. The method includes: mixing bean-based paste, such as kidney bean paste, and sweet potato paste; mixing the mixed paste and dough obtained by adding flour, purified water, margarine, sugar, table salt, eggs, starch syrup, baking powder, and sodium hydrogen carbonate; kneading the dough; shaping the dough into a predetermined shape; rapidly cooling the dough by using a rapid freezer; and baking the dough in an oven. Since the bread formed by using the above-described method contains sweet potato paste, the bread has better taste and smell compared to a conventional bread containing only bean-based paste. Thus, the bread containing sweet potato paste can be preferred by everyone from kids to the elderly. Also, the bread containing sweet potato paste may be stored and distributed for a long period of time by being rapidly cooled.

According to an aspect of the present invention, there is provided a method of forming a sweet potato bread containing sweet potato paste, the method includes: a sweet potato paste forming process (first step) for steaming sweet potatoes, cutting the steamed sweet potatoes, and mashing the cut sweet potatoes by using a masher to form the sweet potato paste; a sweet potato paste mixing process (second step) for mixing the sweet potato paste obtained in the first step and bean-based paste in the weight ratio of 1:0.05 to 0.3; a dough forming process (third step) for mixing flour, sugar, eggs, table salt, starch syrup, baking powder, and sodium hydrogen carbonate and kneading the mixture; a bread shaping process (fourth step) for cutting the dough obtained in the third step to a predetermined size and mixing the cut dough with bread paste of the second step to shape the dough mixed with the bread paste into a bread shape; a rapid cooling process (fifth step) for rapidly cooling the dough shaped into a bread shape in a rapid freezer having a temperature of −30 to −50° C.; and a baking process (sixth step) for baking a bread shaped dough obtained in the fifth step in an oven having a temperature of 180 to 250° C.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic flowchart for describing a method of forming a sweet potato bread containing sweet potato paste.

### DETAILED DESCRIPTION

Hereinafter, a method of making sweet potato bread using sweet potato paste will be described in detail to example embodiments. As used herein, the term “and/or” includes any and all combinations of one or more of the associated listed items.

Example embodiments will hereinafter be described in further detail with reference to the accompanying drawings, in which various embodiments are shown. This disclosure may, however, be embodied in many different forms and should not be construed as limited to example embodiments set forth herein. In the drawings, the thicknesses of layers and regions are exaggerated for clarity. Like reference numerals in the drawings denote like elements, and thus their description will be omitted.

It will be understood that, although the terms “first”, “second”, etc. may be used herein to describe various elements, components, regions, layers and/or sections, these elements, components, regions, layers and/or sections are not to be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments are not to be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, is to be interpreted as having a meaning that is consistent with their meaning in the context of the relevant art and will not be interpreted in an idealized or overly formal sense unless expressly so defined herein.

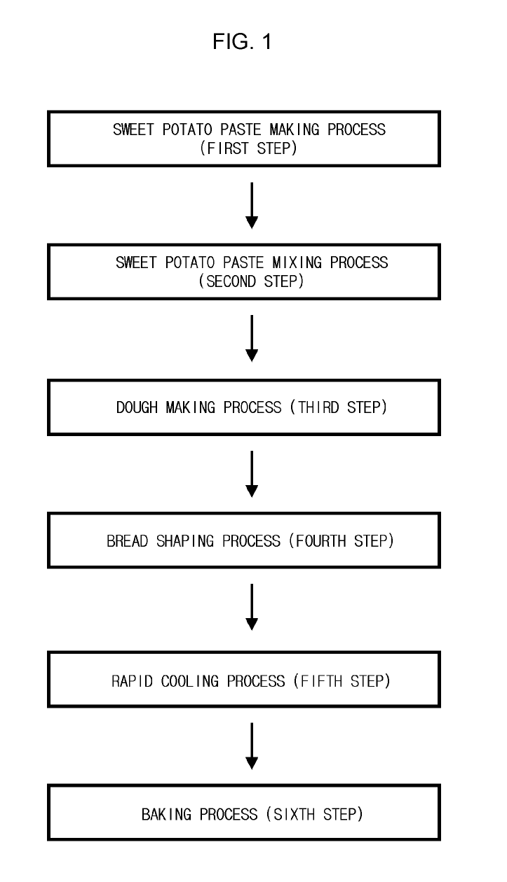

FIG. 1 is a schematic flowchart for describing a method of forming a sweet potato bread containing sweet potato paste.

1. Process of Forming Sweet Potato Paste (First Step)

Sweet potato paste is formed by steaming or baking sweet potatoes, cutting the steamed or baked sweet potatoes by using, for example, a cutter, and mashing the cut sweet potatoes by using, for example, a masher. The sweet potatoes used in the above-described process may be washed and peeled sweet potatoes, and the type of sweet potatoes is not limited. For example, sweet potatoes grown in red clay may be used. In particular, sweet potatoes grown in red clay have a higher sugar content than sweet potatoes grown in a general farmland, and thus there is no need to add sweeteners when forming the sweet potato paste.

The cutter and the masher used in the above-described processes are ones commonly used in the art, and thus a detailed description thereof will be omitted here.

2. Process of Mixing Sweet Potato Paste (Second Step)

A second step is a process of mixing sweet potato paste and bean-based paste. Bean-based paste is added to the sweet potato paste obtained in the first step, and then the bean-based paste and the sweet potato paste are mixed by using, for example, a mixer. In an embodiment, the bean-based paste and the sweet potato paste are mixed in the weight ratio of 1:0.05 to 0.3.

The bean-based paste and the sweet potato paste are mixed in the weight ratio of 1:0.05 to 0.3 to provide a harmonious taste by adding the bean-based paste to a monotonous taste of the sweet potato paste. When the bean-based paste and the sweet potato paste are mixed in the weight ratio of less than 1:0.05, it is difficult to provide a harmonious taste because the monotonous taste of the sweet potato paste is strong. When the bean-based paste and the sweet potato paste are mixed in the weight ratio of equal to or greater than 1:0.3, it is difficult to provide a harmonious taste because the taste of the bean-based paste is strong.

The bean-based paste is one commonly used in the art. The bean-based paste is formed by steaming beans such as peas, kidney beans, fava beans, red beans, baby lima beans, large lima beans, or navy beans, cutting the steamed beans by using a cutter, and mashing the cut beans by using a masher.

The mixture of the bean-based paste and the sweet potato paste is referred to as bread paste.

The pumpkin-based paste may be used instead of the bean-based paste. Pumpkin-based paste is formed by thoroughly washing pumpkins, steaming the pumpkins, cut the steamed pumpkins by using, for example, a cutter, and mashing the cut pumpkins by using, for example, a masher.

3. Process of Forming Dough (Third Step)

A third step is a process of forming dough by adding water to flour. The dough is formed by mixing baking powder, sugar, table salt, sodium hydrogen carbonate and flour by using a mixer and mixing the mixture with purified water.

The flour used to form the dough may be any one of medium flour or strong flour or may be a mixture of medium flour and strong flour. In particular, when the mixture of medium flour and strong flour is used, the medium flour and the strong flour are mixed in the weight ratio of 1:0.3 to 0.6.

The medium flour and the strong flour may be mixed in the weight ratio of 1:0.3 to 0.6 to obtain better taste, smell, and texture of a bread formed through a baking process below.

4. Process of Shaping Bread (Fourth Step)

A fourth step is a process of mixing bread paste and dough and shaping the mixture into a bread shape. The dough obtained in the third step is cut to a predetermined size, and then a predetermined amount of the bread paste obtained in the second step is mixed with the dough cut to a predetermined size to shape the dough mixed with the bread paste into a predetermined bread shape. In this regard, a product shaped into the predetermined bread is referred to as a bread shaped dough.

The bread shaped dough may be shaped by mixing 5 to 30 parts by weight of bean-based paste, 5 to 30 parts by weight of flour, 1 to 10 parts by weight of sugar, 3 to 8 parts by weight of eggs, 0.1 to 1 parts by weight of table salt, 0.1 to 1 parts by weight of starch syrup, 0.05 to 0.5 parts by weight of baking powder, and 0.01 to 0.1 parts by weight of sodium hydrogen carbonate with 100 parts by weight of sweet potato paste.

The above-described bread shaped dough may be formed by mixing white bean paste and pea paste in the weight ratio of 1:1, and pumpkin-based paste may be used instead of the bean-based paste. When the pumpkin-based paste is used, a user may take in nutritional contents of pumpkins in addition to taste of pumpkins when eating a bread containing the pumpkin-based paste, and thus the bread containing the pumpkin-based paste may be used as a healthy diet bread.

The shape of the bread shaped dough depends on the type of bread, and the type of bread is not limited. For example, the bread shaped dough is shaped into a pie shape, a patate shape, a manju shape, or a galette shape. If the bread shaped dough is shaped into a pie shape, a patate shape, a manju shape, or a galette shape, a size and amount of dough and an amount of bread paste to be mixed with the dough may vary according to the shape of the bread shaped dough.

In particular, if the bread shaped dough is shaped into a pie shape, a process of cutting the dough obtained in the third step into an oval by using a roller, folding the cut dough in half, and cutting the folded dough into an oval by using the roller is repeated at least five times, and then the bread paste is placed on the dough to shape the dough into a pie shape.

When a pie is formed, if 12 to 20 parts by weight of margarine is added to materials of the bread shaped dough, the pie may have better taste and smell. Also, if 1 to 3 parts by weight of green tea powder is added to the bread shaped dough, a pie containing green tea may be formed.

If the bread shaped dough is shaped into a patate shape, the dough obtained in the third step is cut into a circle by using a roller, and then the bread paste obtained in the second step is placed on the cut dough to shape the dough into a patate shape.

If the bread shaped dough is shaped into a manju shape, the dough obtained in the third step is cut into a circle by using a roller, and then the bread paste obtained in the second step is placed on the cut dough, and at the same time, the bread paste is covered with the dough to shape the dough into a manju shape.

If the bread shaped dough is shaped into a galette-shape, the dough obtained in the third step is cut into an oval, the bread paste obtained in the second step is placed on the cut dough, and at the same time, the bread paste is covered with the dough, and then both ends of the dough are connected to each other to shape the dough into a galette-shape.

When the patate or galette breads are formed, if 5 to 10 parts by weight of almond powder is added to the bread shaped dough, patate or galette breads having taste and nutrition of almonds may be enjoyed.

5. Rapid Cooling Process (Fifth Step)

A fifth step is a process of rapidly cooling the bread shaped dough. The bread shaped dough obtained in the fourth step is rapidly cooled by using a rapid freezer. The bread shaped dough is rapidly cooled until the center of the bread shaped dough is cooled in the rapid freezer having a temperature of −30 to −50° C. The bread shaped dough is rapidly cooled in the rapid freezer having a temperature of −30 to −50° C. to store and distribute the bread shaped dough for a long period of time compared to a bread shaped dough formed by using a conventional method, to prevent a microstructure of the bread shaped dough from being destroyed as much as possible during the cooling of the bread shaped dough, and to prevent taste, smell, and texture of breads formed through a baking process to be described later from being lowered.

In this regard, the bread shaped dough rapidly cooled in the rapid freezer may be stored in a deep-freezer having a temperature of −18 to −30° C.

6. Baking Process (Sixth Step)

A sixth step is a process of baking the bread shaped dough stored in a freezer by using an oven. The bread shaped dough obtained in the fifth step is baked in the oven.

The oven used in the sixth step is one commonly used in the art. A heating temperature and heating time of the oven vary according to a shape, size, and amount of dough. For example, the heating temperature of the oven is 180 to 250° C., and the bread shaped dough is heated for 10 to 20 minutes until an outer surface of the bread shaped dough browns.

Hereinafter, example embodiments will be described in detail with reference to the following examples. However, these examples are not intended to limit the purpose and scope of example embodiments.

### EXAMPLE 1

### Bread Containing Sweet Potatoes (Pie)

Sweet potato paste was formed by steaming sweet potatoes, cutting the steamed sweet potatoes by using a cutter, and mashing the cut sweet potatoes by using a masher. White bean paste and pea paste were formed by steaming red beans, cutting the steamed red beans by using the cutter, and mashing the cut red beans by using the masher.

Bread paste was formed by adding 1.5 kg of whole red bean paste to 10 kg of the sweet potato paste. Dough was formed by mixing 2 kg of strong flour, 0.9 kg of medium flour, 3 kg of margarine, 0.05 kg of sugar, 0.1 kg of eggs, 0.05 kg of table salt, and 2 kg of purified water and kneading the mixture. In this regard, the dough may be formed by further adding 0.05 kg of corn powder to the mixture.

A process of cutting the dough (40 g) into an oval by using a roller, folding the cut dough in half, and cutting the folded dough into an oval by using the roller was repeatedly performed five times, and the bread paste (100 g) was placed on the dough to shape the dough into a pie shape. Then, the dough was rapidly cooled in a rapid freezer having a temperature of −40° C. until the center of the dough was cooled.

The bread shaped dough shaped into a pie shape is heated for 15 minutes in an oven having a temperature of 200° C. until an outer surface of the bread shaped dough browns.

### EXAMPLE 2

### Bread Containing Sweet Potatoes (Patate)

Sweet potato paste was formed by steaming sweet potatoes, cutting the steamed sweet potatoes by using a cutter, and mashing the cut sweet potatoes by using a masher. White bean paste and pea paste were formed by steaming kidney beans and fava beans, and peas, cutting the steamed beans and peas by using the cutter, and mashing the cut beans and peas by using the masher.

Bread paste was formed by adding 1 kg of the white bean paste and 1 kg of the pea paste to 10 kg of the sweet potato paste. Dough was formed by mixing 0.5 kg of medium flour, 0.5 kg of margarine, 0.25 kg of powdered sugar, 0.07 kg of almond powder, 0.05 kg of eggs, 0.01 kg of table salt, and 0.5 kg of purified water and kneading the mixture.

The dough (40 g) was cut into a circle by using a roller, the bread paste (100 g) was placed on the cut dough to shape the dough into a patate shape, and the dough was rapidly cooled in a rapid freezer having a temperature of −40° C. until the center of the dough was cooled.

The bread shaped dough shaped into a patate shape was heated for 15 minutes in an oven having a temperature of 200° C. until an outer surface of the bread shaped dough browned.

### EXAMPLE 3

### Bread Containing Sweet Potatoes (Manju)

Sweet potato paste was formed by steaming sweet potatoes, cutting the steamed sweet potatoes by using a cutter, and mashing the cut sweet potatoes by using a masher. White bean paste and pea paste were formed by steaming kidney beans and fava beans, and peas, cutting the steamed beans and peas by using the cutter, and mashing the cut beans and peas by using the masher.

Bread paste was formed by adding 1 kg of the white bean paste and 1 kg of the pea paste to 10 kg of the sweet potato paste. Dough was formed by mixing 2 kg of medium flour, 0.8 kg of sugar, 0.7 kg of eggs, 0.03 kg of starch syrup, 0.04 kg of table salt, 0.03 kg of baking powder, and 0.001 kg of sodium hydrogen carbonate and kneading the mixture.

The dough (40 g) was cut into a circle by using a roller, the bread paste (100 g) was placed on the cut dough, and at the same time, the bread paste was covered with the dough to shape the dough into a manju shape. Then, the dough was rapidly cooled in a rapid freezer having a temperature of −40° C. until the center of the dough was cooled.

The bread shaped dough shaped into a manju shape was heated for 15 minutes in an oven having a temperature of 200° C. until an outer surface of the bread shaped dough browned.

### EXAMPLE 4

### Bread Containing Sweet Potatoes (Galette)

Sweet potato paste was formed by steaming sweet potatoes, cutting the steamed sweet potatoes by using a cutter, and mashing the cut sweet potatoes by using a masher. White bean paste and pea paste were formed by steaming kidney beans and peas, cutting the steamed beans and peas by using the cutter, and mashing the cut beans and peas by using the masher.

Bread paste was formed by adding 2 kg of the white bean paste to 10 kg of the sweet potato paste. Dough was formed by mixing 10 kg of medium flour, 3 kg of almond powder, 2 kg of eggs, 5 kg of margarine, 4 kg of sugar, 0.1 kg of fresh cream, 0.1 kg of starch syrup, 0.15 kg of powdered sugar, 0.07 kg of baking powder, and 0.15 kg of ELFROY (trade name) and kneading the mixture.

The dough (40 g) was cut into an oval by using a roller, the bread paste (100 g) was placed on the cut dough, and at the same time, the bread paste was covered with the dough, and then both ends of the dough were connected to each other to shape the dough into a galette-shape. Then, the dough was rapidly cooled in a rapid freezer having a temperature of −40° C. until the center of the dough was cooled.

The bread shaped dough shaped into a galette-shape was heated for 15 minutes in an oven having a temperature of 200° C. until an outer surface of the bread shaped dough browned.

### COMPARATIVE EXAMPLE 1

### Bread Formed by Using a Conventional Method (Pie)

Red bean paste (1 kg) is formed by steaming red beans, cutting the steamed red beans by using a cutter, and mashing the cut red beans by using a masher.

Dough was formed by mixing 2 kg of strong flour, 1 kg of purified water, 0.7 kg of margarine, 0.01 kg of sugar, and 0.01 kg of table salt and kneading the mixture.

The dough (40 g) was cut into an oval by using a roller, the dough was punched by using a puncher, and then the red bean paste (100 g) was placed on the cut dough to shape the dough into a pie shape.

The bread shaped dough shaped into a pie shape was heated for 15 minutes in an oven having a temperature of 200° C. until an outer surface of the bread shaped dough browned.

### COMPARATIVE EXAMPLE 2

### Bread Formed by Using a Conventional Method (Patate)

Red bean paste (1 kg) was formed by steaming red beans, cutting the steamed red beans by using a cutter, and mashing the cut red beans by using a masher.

Dough was formed by mixing 2 kg of strong flour, 1 kg of purified water, 0.4 kg of margarine, 0.04 kg of sugar, and 0.04 kg of table salt and kneading the mixture.

The dough (40 g) was cut into a circle by using a roller, and the red bean paste (100 g) was placed on the cut dough to shape the dough into a patate shape.

The bread shaped dough shaped into a patate shape was heated for 15 minutes in an oven having a temperature of 200° C. until an outer surface of the bread shaped dough browned.

### COMPARATIVE EXAMPLE 3

### Bread Formed by Using a Conventional Method (Manju)

Red bean paste (3 kg) was formed by steaming red beans, cutting the steamed red beans by using a cutter, and mashing the cut red beans by using a masher.

Dough was formed by mixing 2 kg of strong flour, 1 kg of purified water, 0.4 kg of margarine, 0.04 kg of sugar, and 0.04 kg of table salt and kneading the mixture.

The dough (40 g) was cut into a circle by using a roller, the red bean paste (100 g) was placed on the cut dough, and at the same time, the red bean paste was covered with the dough to shape the dough into a manju shape.

The bread shaped dough shaped into a manju shape was heated for 15 minutes in an oven having a temperature of 200° C. until an outer surface of the bread shaped dough browned.

### COMPARATIVE EXAMPLE 4

### Bread Formed by Using a Conventional Method (Galette)

Red bean paste (3 kg) was formed by steaming red beans, cutting the steamed red beans by using a cutter, and mashing the cut red beans by using a masher.

Dough was formed by mixing 2 kg of strong flour, 1 kg of purified water, 0.4 kg of margarine, 0.04 kg of sugar, and 0.04 kg of table salt and kneading the mixture.

The dough (40 g) was cut into an oval by using a roller, the red bean paste (100 g) was placed on the cut dough, and at the same time, the red bean paste was covered with the dough, and then both ends of the dough are connected to each other to shape the dough into a galette-shape.

The bread shaped dough shaped into a galette-shape was heated for 15 minutes in an oven having a temperature of 200° C. until an outer surface of the bread shaped dough browned.

Experiment 1: Sensory Test

A sensory test was conducted with respect to the breads (Examples 1 to 4) formed by using the method according to Examples of the present invention and the breads (Comparative Examples 1 to 4) formed by using a conventional method. The sensory test was conducted regarding favor, smell, texture, and preference of the breads by 30 people having a relatively excellent sense of taste from among trained professional sensory testers (50 people (25 men and 25 women) who have at least two years of sensory test experience).

In particular, the sensory test was conducted by using a 5-point scaling method (1: very bad, 2: bad, 3: average, 4: good, 5: very good), and a result of the sensory test are shown in Table 1 below.

TABLE 1

| | Taste | Smell | Texture | Preference |
|---|---|---|---|---|
| Example 1 | 5 | 4 | 4 | 5 |
| Comparative Example 1 | 4 | 3 | 3 | 3 |
| Example 2 | 5 | 5 | 4 | 5 |
| Comparative Example 2 | 3 | 4 | 4 | 3 |
| Example 3 | 5 | 5 | 4 | 5 |
| Comparative Example 3 | 4 | 3 | 4 | 3 |
| Example 4 | 5 | 4 | 4 | 5 |
| Comparative Example 4 | 3 | 3 | 4 | 3 |

As shown in Table 1, Examples 1 to 4 show high points in almost every category except for texture compared to Comparative Examples 1 to 4. According to the result, unlike the breads of Comparative Examples 1 to 4 using only red bean paste, the breads of Examples 1 to 4 containing sweet potato paste have sweetness and a unique smell of sweet potatoes, and thus the breads of Examples 1 to 4 have better taste and smell.

A bread containing sweet potato paste according to the present invention has better taste, smell, and texture compared to a bread containing only bean-based paste and formed by using a conventional method, and thus the bread containing sweet potato paste can be preferred by everyone from kids to the elderly. Also, the bread containing sweet potato paste can be used as a functional nutrition diet bread by decreasing a flour content and increasing a sweet potato content containing lots of fiber.

According to the present invention, a bread can be stored and distributed for a long period of time, compared to a bread formed by using a conventional method, by mixing dough and paste, shaping the dough mixed with paste into a predetermined shape, and rapidly cooling the dough shaped into a predetermined shape in a rapid freezer having a temperature of −30 to −50° C. Also, a microstructure of a bread shaped dough can be prevented from being destroyed as much as possible during the cooling of the bread shaped dough. In addition, taste, smell, and texture of breads formed through a baking process can be prevented from being lowered.

It should be understood that example embodiments described herein should be considered in a descriptive sense only and not for purposes of limitation. Descriptions of features or aspects within each example embodiment should typically be considered as available for other similar features or aspects in other example embodiments.

What is claimed is:

1. A method of making a sweet potato bread, the method comprising:
forming a sweet potato paste by steaming sweet potatoes, cutting the steamed sweet potatoes, and mashing the cut sweet potatoes;
forming a mixed paste by mixing the sweet potato paste and bean-based paste in the weight ratio of 1:0.05 to 0.3;
forming a dough by mixing flour, sugar, eggs, table salt, starch syrup, baking powder, and sodium hydrogen carbonate and kneading the mixture; and
cutting the dough to a predetermined size;
adding the mixed paste to the cut dough; and
baking the cut dough.

2. The method of claim 1, further comprising:
rapidly cooling the cut dough at a temperature of −30 to −50° C. before the baking.

3. The method of claim 1, wherein the baking is performed at a temperature of 180 to 250° C.

4. The method of claim 2, wherein the baking is performed at a temperature of 180 to 250° C.

5. The method of claim 1, wherein green tea powder is further added in the dough forming.

6. The method of claim 1, wherein almond powder is further added in the dough forming

7. A method of making a sweet potato bread, the method comprising:
forming a sweet potato paste by steaming sweet potatoes, cutting the steamed sweet potatoes, and mashing the cut sweet potatoes;
forming a mixed paste by mixing the sweet potato paste and pumpkin-based paste in the weight ratio of 1:0.05 to 0.3;
forming a dough by mixing flour, sugar, eggs, table salt, starch syrup, baking powder, and sodium hydrogen carbonate and kneading the mixture; and
cutting the dough to a predetermined size;
adding the mixed paste to the cut dough; and
baking the cut dough.

8. The method of claim 7, further comprising:
rapidly cooling the cut dough at a temperature of −30 to −50° C. before the baking.

9. The method of claim 7, wherein the baking is performed at a temperature of 180 to 250° C.

10. The method of claim 8, wherein the baking is performed at a temperature of 180 to 250° C.

11. The method of claim 7, wherein green tea powder is further added in the dough forming.

12. The method of claim 7, wherein almond powder is further added in the dough forming.
